(19) United States
(12) Patent Application Publication
(10) Pub. No.: US 2026/0038944 A1
(43) Pub. Date: Feb. 5, 2026

(54) ELECTRICITY STORAGE DEVICE

(71) Applicant: TOYOTA JIDOSHA KABUSHIKI KAISHA, Toyota-shi (JP)

(72) Inventor: Kouichi NAGAMINE, Toyota-shi (JP)

(73) Assignee: TOYOTA JIDOSHA KABUSHIKI KAISHA, Toyota-shi (JP)

(21) Appl. No.: 19/170,147

(22) Filed: Apr. 4, 2025

(30) Foreign Application Priority Data
Aug. 1, 2024 (JP) 2024-126069

(51) Int. Cl. H01M 50/262; F16J 15/02; H01M 50/271

(52) U.S. Cl. CPC H01M 50/262; F16J 15/025; H01M 50/271

(57) ABSTRACT

An electricity storage device includes a battery module, and a casing including an accommodating portion that accommodates the battery module and a lid portion that covers the accommodating portion. The accommodating portion and the lid portion include flange portions projecting outward at peripheral edges of the accommodating portion and the lid portion, the flange portions being fastened to each other via a seal member provided between the flange portions. The seal member includes a main body portion to be sandwiched between the flange portions, a connection portion extending between the flange portions from the main body portion to outer ends of the flange portions of the accommodating portion and the lid portion, and a cover portion that branches from a distal end of the connection portion into a T-shape to cover the outer ends of the flange portions of the accommodating portion and the lid portion.

### CROSS-REFERENCE TO RELATED APPLICATION

This application claims priority to Japanese Patent Application No. 2024-126069 filed on Aug. 1, 2024. The disclosure of the above-identified application, including the specification, drawings, and claims, is incorporated by reference herein in its entirety.

### BACKGROUND

### 1. Technical Field

The present disclosure relates to an electricity storage device.

### 2. Description of Related Art

For example, as disclosed in Japanese Unexamined Patent Application Publication No. 2016-096080 (JP 2016-096080 A), for example, there is known an electricity storage device that can be installed outside of a house or the like. In the electricity storage device disclosed in JP 2016-096080 A, a battery module is accommodated in a casing, and the casing is configured by fastening, via a seal member, an accommodating portion that accommodates the battery module and a lid portion that covers the accommodating portion.

### SUMMARY

As in the electricity storage device disclosed in JP 2016-096080 A, the seal member is provided on flange portions projecting outward at peripheral edges of the accommodating portion and the lid portion. Accordingly, for example, at the time of assembling the electricity storage device, in consideration of safety of an operator or the like, a cover member that covers outer ends of the flange portions is required to be provided, resulting in a problem that it takes time and effort.

The present disclosure has been made in view of such circumstances, and provides an electricity storage device that makes it possible to more easily cover outer ends of flange portions in a casing.

An electricity storage device according to one aspect of the present disclosure includes:
a battery module; and
a casing including
   an accommodating portion that accommodates the battery module, and
   a lid portion that covers the accommodating portion.

The accommodating portion and the lid portion include flange portions projecting outward at peripheral edges of the accommodating portion and the lid portion, the flange portions being fastened to each other via a seal member provided between the flange portions.

The seal member includes
a main body portion to be sandwiched between the flange portions,
a connection portion extending between the flange portions from the main body portion to outer ends of the flange portions of the accommodating portion and the lid portion, and
a cover portion that branches from a distal end of the connection portion into a T-shape to cover the outer ends of the flange portions of the accommodating portion and the lid portion.

In the electricity storage device according to the present disclosure, the seal member provided between the flange portions of the accommodating portion and the lid portion configuring the casing includes, in addition to the main body portion to be sandwiched between the flange portions, the connection portion extending between the flange portions up to the outer ends of the flange portions, and the cover portion that branches from the distal end of the connection portion into a T-shape to cover the outer ends of the flange portions of the main body portion and the lid portion. That is, when the seal member is provided between the flange portions in the casing, the outer ends of the flange portions can be covered at the same time, and a separate cover member is not required to be provided. With this configuration, the outer ends of the flange portions in the casing can be more easily covered.

A distal end portion of the cover portion on the accommodating portion side may protrude toward a base side of the flange portion of the accommodating portion. Further, a distal end portion of the cover portion on the lid portion side may protrude toward a base side of the flange portion of the lid portion. With this configuration, the outer ends of the flange portions in the casing can be more reliably covered.

With the present disclosure, it is possible to provide the electricity storage device that makes it possible to more easily cover the outer ends of the flange portions in the casing.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view illustrating an electricity storage device according to a first embodiment;

FIG. 2 is a sectional view taken along the cut line II-II of FIG. 1;

FIG. 3 is an enlarged sectional view of the region III of FIG. 2;

FIG. 4 is a sectional view illustrating a modification example of a seal member 30; and

FIG. 5 is a sectional view illustrating another modification example of the seal member 30.

### DETAILED DESCRIPTION OF EMBODIMENTS

Hereinafter, specific embodiments of the present disclosure are described in detail with reference to the drawings. It is to be noted that the present disclosure is not limited to the following embodiments. Further, for a clearer description, the following descriptions and drawings are simplified as appropriate.

### First Embodiment

### Configuration of Electricity Storage Device

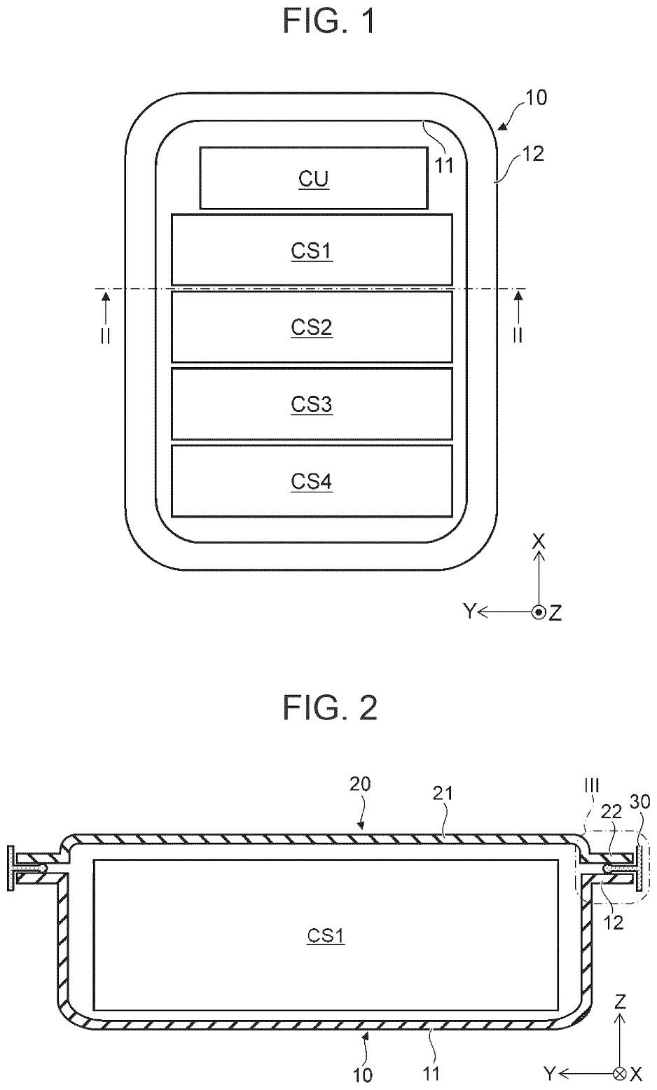

First, with reference to FIG. 1 and FIG. 2, description is given of a configuration of an electricity storage device according to a first embodiment. FIG. 1 is a plan view illustrating the electricity storage device according to the first embodiment. FIG. 2 is a sectional view taken along the cut line II-II of FIG. 1.

It is to be noted that, as a matter of course, the right-handed XYZ orthogonal coordinates shown in FIG. 1 and FIG. 2 are illustrated for convenience of explanation regarding a positional relation among components. In FIG. 1 and FIG. 2, usually, a plus direction of a Z axis represents a vertically upward direction, an XY plane represents a horizontal plane, and these are the same throughout the drawings.

The electricity storage device according to this embodiment is, for example, an electricity storage device that can be installed outside of a house or the like. The electricity storage device includes, as illustrated in FIG. 1, an accommodating portion 10, cell stacks CS1 to CS4, and a control unit CU, and includes, as illustrated in FIG. 2, a lid portion 20 and a seal member 30. Here, the cell stacks CS1 to CS4 and the control unit CU configure a battery module. The accommodating portion 10 and the lid portion 20 configure a casing that accommodates the battery module. The electricity storage device according to this embodiment is, for example, a secondary battery such as a lithium-ion battery or a nickel-hydrogen battery.

It is to be noted that, in FIG. 1, illustration of the lid portion 20 and the seal member 30 is omitted.

As illustrated in FIG. 1 and FIG. 2, the accommodating portion 10 accommodates the battery module (the cell stacks CS1 to CS4 and the control unit CU). The accommodating portion 10 is configured of, from the viewpoint of durability, for example, a metal material such as an aluminum alloy. Here, the accommodating portion 10 includes an accommodating main body portion 11 and a flange portion 12. The accommodating main body portion 11 is an open-topped box-shaped member that accommodates the battery module (the cell stacks CS1 to CS4 and the control unit CU). The flange portion 12 is provided to project outward at the entire peripheral edge of the accommodating main body portion 11.

As illustrated in FIG. 1 and FIG. 2, the cell stacks CS1 to CS4 have a cuboid shape as a whole, and are sequentially arranged in parallel in a minus direction of the X axis. Each of the cell stacks CS1 to CS4 has a configuration in which a plurality of rectangular cells having a cuboid shape is stacked (not shown). Although not particularly limited, in each of the cell stacks CS1 to CS4 illustrated in FIG. 1 and FIG. 2, the rectangular cells are stacked in its thickness direction (Y axis direction).

It is to be noted that, as a matter of course, the number of cell stacks to be accommodated in the accommodating portion 10 is not limited to four, and is determined as appropriate.

The control unit CU is electrically connected to each of the cell stacks CS1 to CS4 to control the cell stacks CS1 to CS4. For example, the control unit CU monitors a charging voltage of each of the cell stacks CS1 to CS4 to control a charge-discharge current.

It is to be noted that the control unit CU illustrated in FIG. 1 is disposed adjacent to the cell stack CS1 in the accommodating portion 10 on the plus direction side of the X axis, but the place to dispose the control unit CU in the accommodating portion 10 is not particularly limited. Further, the control unit CU may include a junction box or other electronic devices, for example.

As illustrated in FIG. 2, the lid portion 20 covers the accommodating portion 10 accommodating the cell stacks CS1 to CS4 and the control unit CU. The lid portion 20 is similarly configured of, from the viewpoint of durability, for example, a metal material such as an aluminum alloy. Here, the lid portion 20 includes a lid main body portion 21 and a flange portion 22. The lid main body portion 21 covers the accommodating main body portion 11 accommodating the cell stacks CS1 to CS4 and the control unit CU. The flange portion 22 is provided to project outward at the entire peripheral edge of the lid main body portion 21. The flange portion 12 of the accommodating portion 10 and the flange portion 22 of the lid portion 20 are disposed to face each other via the seal member 30, and are fastened by a fastening member which is not shown.

As illustrated in FIG. 2, the seal member 30 is sandwiched between the flange portion 12 of the accommodating portion 10 and the flange portion 22 of the lid portion 20. With this configuration, the water resistance of the inside of the casing configured of the accommodating portion 10 and the lid portion 20 can be ensured. The seal member 30 is an annular member provided along the entire flange portion 12 of the accommodating portion 10 illustrated in FIG. 1. The seal member 30 is made of, for example, a resin material such as an elastomer including synthetic rubber. 30

The detailed configuration of the seal member 30 is described later.

### Method of Manufacturing Electricity Storage Device

Here, with reference to FIG. 1 and FIG. 2, description is given of a method of manufacturing (a method of assembling) the electricity storage device according to this embodiment.

First, as illustrated in FIG. 1, the battery module (the cell stacks CS1 to CS4 and the control unit CU) is accommodated in the accommodating portion 10.

Next, as illustrated in FIG. 2, the seal member 30 is provided on the flange portion 12 of the accommodating portion 10 accommodating the cell stacks CS1 to CS4 and the control unit CU.

Finally, as illustrated in FIG. 2, the accommodating portion 10 is covered with the lid portion 20, and the flange portion 12 of the accommodating portion 10 and the flange portion 22 of the lid portion 20 are fastened via the seal member 30 with the use of the fastening member which is not shown.

It is to be noted that, at the time of manufacturing the electricity storage device according to this embodiment, the plus direction of the Z axis in FIG. 1 and FIG. 2 becomes the vertically upward direction. Besides, at the time of installing the electricity storage device according to this embodiment outdoors, that is, at the time of using the electricity storage device, the plus direction of the X axis in FIG. 1 and FIG. 2 becomes the vertically upward direction.

### Detailed Configuration of Seal Member 30

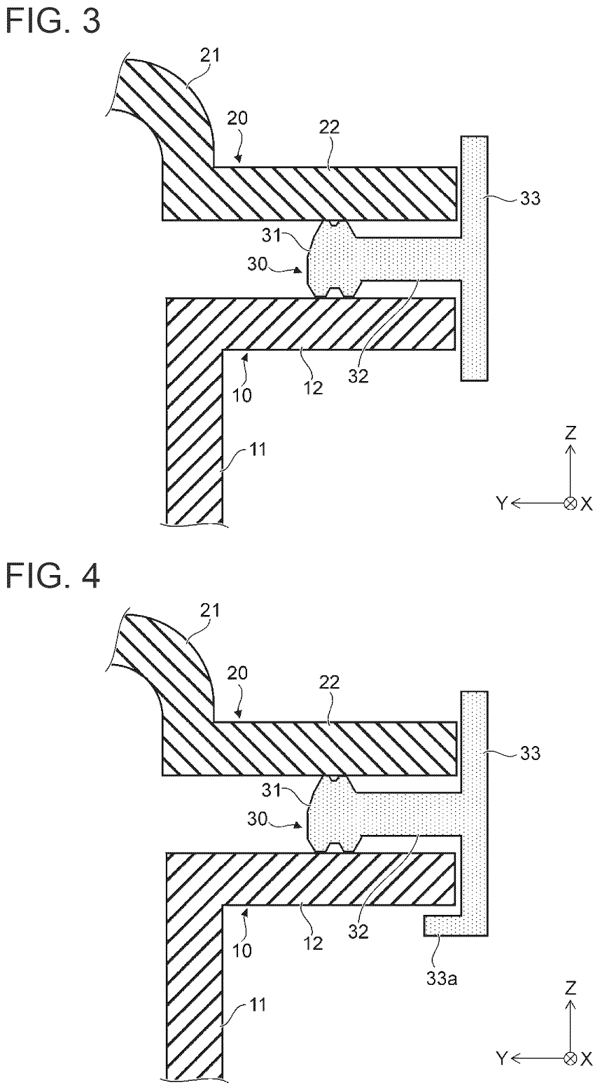

Next, with reference to FIG. 3, description is given of a detailed configuration of the seal member 30. FIG. 3 is an enlarged sectional view of the region III of FIG. 2.

As illustrated in FIG. 3, the seal member 30 includes a seal main body portion 31, a connection portion 32, and a cover portion 33. For example, the seal member 30 is molded with the use of a mold, and the seal main body portion 31, the connection portion 32, and the cover portion 33 are integrally molded.

As illustrated in FIG. 3, the seal main body portion 31 is sandwiched between the flange portion 12 of the accommodating portion 10 and the flange portion 22 of the lid portion 20. With this configuration, the water resistance of the inside of the casing configured of the accommodating portion 10 and the lid portion 20 can be ensured. In the seal main body portion 31 illustrated in FIG. 3, a groove is formed in each of a contact surface to be in contact with the flange portion 12 of the accommodating portion 10 and a contact surface to be in contact with the flange portion 22 of the lid portion 20. Accordingly, the seal main body portion 31 sticks to the flange portion 12 and the flange portion 22, and the position of the seal main body portion 31 is less liable to be shifted in the Y axis direction in FIG. 3.

As illustrated in FIG. 3, the connection portion 32 is provided to extend between the flange portion 12 of the accommodating portion 10 and the flange portion 22 of the lid portion 20 from the seal main body portion 31 to outer ends of the flange portion 12 of the accommodating portion 10 and the flange portion 22 of the lid portion 20. That is, the connection portion 32 connects the seal main body portion 31 and the cover portion 33.

As illustrated in FIG. 3, the cover portion 33 branches from a distal end of the connection portion 32 into a T-shape in both plus and minus directions of the Z axis to cover the outer ends of the flange portion 12 of the accommodating portion 10 and the flange portion 22 of the lid portion 20. Accordingly, when the seal member 30 is provided between the flange portion 12 of the accommodating portion 10 and the flange portion 22 of the lid portion 20, the outer ends of the flange portion 12 and the flange portion 22 can also be covered with the cover portion 33 at the same time. That is, it is not required to separately provide a cover member that covers the outer ends of the flange portion 12 and the flange portion 22, and the outer ends of the flange portion 12 and the flange portion 22 can be more easily covered.

The cover portion 33 is provided in a band shape along a longitudinal direction of the seal member 30 (in FIG. 3, the X axis direction). As illustrated in FIG. 3, it is preferable that a lower end of the cover portion 33 (an end portion on a minus direction side of the Z axis) protrude downward (to the minus direction side of the Z axis) of a lower surface of the flange portion 12 of the accommodating portion 10 (a surface on the minus direction side of the Z axis). Similarly, it is preferable that an upper end of the cover portion 33 (an end portion on a plus direction side of the Z axis) protrude upward (to the plus direction side of the Z axis) of an upper surface of the flange portion 22 of the lid portion 20 (a surface on the plus direction side of the Z axis).

As described above, in the electricity storage device according to this embodiment, the seal member 30 includes, in addition to the seal main body portion 31 to be sandwiched between the flange portions 12, 22, the connection portion 32 extending between the flange portions 12, 22 up to the outer ends of the flange portions 12, 22, and the cover portion 33 that branches from the distal end of the connection portion 32 into a T-shape to cover the outer ends of the flange portions 12, 22.

That is, when the seal member 30 is provided between the flange portions 12, 22 in the casing configured of the accommodating portion 10 and the lid portion 20, the outer ends of the flange portions 12, 22 can also be covered with the cover portion 33 at the same time, and a separate cover member is not required to be provided. With this configuration, the outer ends of the flange portions 12, 22 in the casing configured of the accommodating portion 10 and the lid portion 20 can be more easily covered.

### Modification Example of Seal Member 30

Next, with reference to FIG. 4, description is given of a modification example of the seal member 30. FIG. 4 is a sectional view illustrating the modification example of the seal member 30. FIG. 4 is a drawing corresponding to FIG. 3.

In the seal member 30 according to the modification example illustrated in FIG. 4, the cover portion 33 includes a barbed portion 33a. The barbed portion 33a is provided at a distal end portion of the cover portion 33 on the accommodating portion 10 side to protrude toward a base side of the flange portion 12 of the accommodating portion 10. Accordingly, while the cover portion 33 illustrated in FIG. 3 has an I-shape in YZ section, the cover portion 33 illustrated in FIG. 4 has an L-shape in YZ section.

In other words, in the electricity storage device illustrated in FIG. 3, only an outer end surface of the flange portion 12 of the accommodating portion 10 is covered with the cover portion 33, and a lower surface of the flange portion 12 is not covered with the cover portion 33. In contrast, in the electricity storage device illustrated in FIG. 4, the cover portion 33 includes the barbed portion 33a, and hence the flange portion 12 of the accommodating portion 10 is capped with the cover portion 33 from the outer end surface to the lower surface of the flange portion 12 of the accommodating portion 10. Accordingly, in the electricity storage device illustrated in FIG. 4, the outer end of the flange portion 12 of the accommodating portion 10 may be more firmly covered.

### Other Modification Example of Seal Member 30

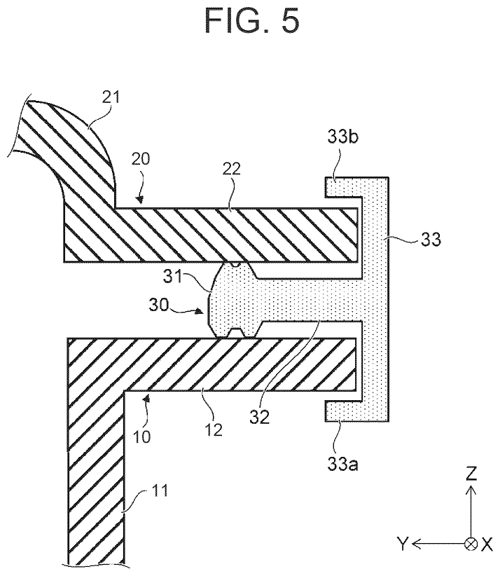

Next, with reference to FIG. 5, description is given of another modification example of the seal member 30. FIG. 5 is a sectional view illustrating the other modification example of the seal member 30. FIG. 5 is a drawing corresponding to FIG. 3.

In the seal member 30 according to the other modification example illustrated in FIG. 5, the cover portion 33 includes barbed portions 33a, 33b. The barbed portion 33a is provided at the distal end portion of the cover portion 33 on the accommodating portion 10 side to protrude toward the base side of the flange portion of the accommodating portion 10. The barbed portion 33b is provided at a distal end portion of the cover portion 33 on the lid portion 20 side to protrude toward a base side of the flange portion 22 of the lid portion 20. Accordingly, while the cover portion 33 illustrated in FIG. 3 has an I-shape in YZ section, the cover portion 33 illustrated in FIG. 5 has a U-shape in YZ section.

In other words, in the electricity storage device illustrated in FIG. 3, only the outer end surfaces of the flange portion 12 of the accommodating portion 10 and the flange portion 22 of the lid portion 20 are covered with the cover portion 33, and the lower surface of the flange portion 12 and the upper surface of the flange portion 22 are not covered with the cover portion 33. In contrast, in the electricity storage device illustrated in FIG. 5, the cover portion 33 includes the barbed portions 33a, 33b.

Accordingly, the flange portion 12 of the accommodating portion 10 is capped with the cover portion 33 from the outer end surface to the lower surface of the flange portion 12 of the accommodating portion 10, and the flange portion 22 of the lid portion 20 is capped with the cover portion 33 from the outer end surface to the upper surface of the flange portion 22 of the lid portion 20. As a result, in the electricity storage device illustrated in FIG. 5, the outer ends of the flange portion 12 of the accommodating portion 10 and the flange portion 22 of the lid portion 20 can be more firmly covered.

It is to be noted that, in FIG. 5, the cover portion 33 may include only the barbed portion 33b, and is not required to include the barbed portion 33a.

It is to be noted that the present disclosure is not limited to the above-mentioned embodiments, and modifications can be made thereto as appropriate without departing from the gist thereof.

What is claimed is:

1. An electricity storage device comprising:
a battery module; and
a casing including
an accommodating portion that accommodates the battery module, and
a lid portion that covers the accommodating portion,
the accommodating portion and the lid portion including flange portions projecting outward at peripheral edges of the accommodating portion and the lid portion, the flange portions being fastened to each other via a seal member provided between the flange portions,
wherein the seal member includes
a main body portion to be sandwiched between the flange portions,
a connection portion extending between the flange portions from the main body portion to outer ends of the flange portions of the accommodating portion and the lid portion, and
a cover portion that branches from a distal end of the connection portion into a T-shape to cover the outer ends of the flange portions of the accommodating portion and the lid portion.

2. The electricity storage device according to claim 1, wherein a distal end portion of the cover portion on the accommodating portion side protrudes toward a base side of the flange portion of the accommodating portion.

3. The electricity storage device according to claim 1, wherein a distal end portion of the cover portion on the lid portion side protrudes toward a base side of the flange portion of the lid portion.
